(19) United States
(12) Patent Application Publication
(10) Pub. No.: US 2007/0025443 A1
(43) Pub. Date: Feb. 1, 2007

(54) MOVING PICTURE CODING APPARATUS, METHOD AND PROGRAM

(75) Inventor: Kazuyuki INOKUMA, Osaka (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/457,878

(22) Filed: Jul. 17, 2006

(30) Foreign Application Priority Data
Jul. 27, 2005 (JP) 2005/217849

(51) Int. Cl. H04N 11/02; H04N 7/12

(52) U.S. Cl. 375/240.16; 375/240.26

(57) ABSTRACT

A moving picture coding apparatus, for optimizing a handling of a reference picture with the view to reducing the data amount of the reference picture to be stored for use in motion prediction coding, which is configured of: a local decoding unit which obtains a reference picture by decoding a first code representing a first input picture; a reference picture reduction unit which obtains a reduced reference picture by reducing the size of the reference picture; a reference picture storage unit which stores the reduced reference picture; an inter-frame coding unit which generates a difference picture between a second input picture and a reconstructed reference picture obtained by expanding the size of the reduced reference picture obtained from the reference picture storage unit; and an intra-frame coding unit which codes the difference picture.

### BACKGROUND OF THE INVENTION

(1) Field of the Invention

The present invention relates to a moving picture coding apparatus which codes a moving picture made up of input pictures that are in time series. The invention particularly relates to a technique of reducing a data amount of reference pictures to be stored for use in the motion prediction coding of pictures.

(2) Description of the Related Art

Recently, in addition to video cameras, digital still cameras and camera-equipped cell phones have come into wide use, and it has become easier to handle pictures. With the advancement in compression technology, moving pictures having a data amount greater than that of still pictures can be also handled with ease, and it is possible to shoot and record a moving picture with a digital still camera or a camera-equipped cell phone.

Conventionally, it has been common to use both a compression technique based on motion prediction between frames and a compression technique used within a frame, as defined in a codec specification as represented, for example, by MPEG-2 (Moving Picture Experts Group) and H. 264.

FIG. 1 is a functional block diagram showing an example of the configuration of a typical conventional picture coding apparatus.

A picture coding apparatus 300 codes input pictures which are to be processed per frame and compose a moving picture, by using both the compression technique based on motion prediction between so frames and the compression technique used within a frame. Such picture coding apparatus 300 is configured of an input picture buffer 301, an inter-frame coding unit 313, an intra-frame coding unit 306, a reference picture generation unit 314, a reference picture storage unit 303, a rate control unit 311, and a quantization width setting unit 312.

The input picture buffer 301 holds the input pictures.

The inter-frame coding unit 313 performs compression between the frames by representing an input picture by a difference which is based on the motion prediction carried out between an input picture and a picture (so called “reference picture”) of another frame which is to be referred to and is stored in the reference picture storage unit 303. Such inter-frame coding unit 313 includes a motion vector search memory 304, a motion vector search unit 305 and a difference picture generation unit 302.

The motion vector search unit 305 divides the input picture into small rectangular regions called “macroblocks”, and obtains, for each macroblock, a motion vector indicating a part, in the reference picture, which is the most closely related to the macroblock, using the motion vector search memory 304. In order to carry out this processing, a commonly-known technique called “block matching” is used, for example. The difference picture generation unit 302 obtains an inter-frame difference between the macroblock and the part of the reference picture indicated by the motion vector.

The intra-frame coding unit 306 performs intra-frame compression by coding either the inter-frame difference, or an input picture per se without performing motion prediction for some of the frames. Such intra-frame coding unit 306 includes a frequency transformation unit 307, a quantization unit 308 and an entropy coding unit 309.

The frequency transformation unit 307 obtains, for each macroblock, an amount of the spatial frequency components included in the macroblock, through DCT transformation, for instance.

The quantization unit 308 finely quantizes the low frequency components which are easily perceivable by the eyes of a human being, and coarsely quantizes the high frequency components which are hardly perceivable. The quantization unit 308 performs quantization onto a quantization width of each frequency component by further taking into account a quantization width for controlling a bit rate (i.e. compression rate) given from the rate control unit 311 and the quantization width setting unit 312.

The entropy coding unit 309 performs variable length coding using an entropy coding, more specifically, a Huffman coding or an arithmetic coding. In the entropy coding, the quantized values of the frequency components are arranged in a predetermined order, and the shorter codes are assigned to the data with higher occurrence probability.

The reference picture generation unit 314 obtains a reference picture by decoding a code obtained through the intra-frame compression, and includes a local decoding unit 310.

Considering that the entropy coding is a lossless coding, the local decoding unit 310 obtains, by decoding the quantized values, a reference picture which is equivalent to a reference picture obtained by a reproduction apparatus. Coding an input picture with reference to the reference picture which is equivalent to the one used at the time of reproduction is important in order to prevent the degradation in picture quality due to errors.

The reference picture storage unit 303 stores the obtained reference picture and provides it for a coding process of the next input picture.

The picture coding apparatus 300 obtains a code indicating a moving picture by performing the above-mentioned processing for each frame.

In the inter-frame coding as described above, the higher the correlation between a macroblock of an input picture and a part of the reference picture based on which the difference is derived, the smaller the amount of the code indicating the difference becomes. Thus, a high compression rate can be obtained.

Therefore, there is disclosed a conventional technique of searching for a part indicating a higher correlation in a broader range within a reference picture using the vector search memory 304 of the same memory size as the one used in the previous search, by re-searching for a motion vector between a reduced input picture and a reduced reference picture in the case of not finding a part indicating a sufficiently high correlation with regard to a macroblock of the input picture in a predetermined range within a reference picture (e.g. Japanese Laid-Open Patent Application No. 2004-140794).

### SUMMARY OF THE INVENTION

However, with the conventional moving picture coding apparatus, a reference picture of an original size is stored in a reference picture storage unit in order to obtain a difference between an input picture and the reference picture, even in the case of expanding a search range of a moving vector using a reduced reference picture. The picture size to be handled is expected to become larger in the future. In the case of processing a moving picture at the level of high definition television (HDTV), an increase in the size of memory capacity necessary for the storage of the reference pictures, an increase in the power consumption in accordance with memory traffic are the crucial problems in realizing a moving picture coding apparatus in a portable equipment such as a digital camera whose hardware size and power capacity tend to be limited.

The present invention is conceived in view of the problems as mentioned above, and an object of the present invention is to provide a moving picture coding apparatus which optimizes the processing of the reference pictures in order to reduce the data amount of the reference pictures to be stored for the motion prediction coding of the pictures.

In order to achieve the above-mentioned object, the moving picture coding apparatus of the present invention codes a moving picture made up of input pictures which are in time series, and includes: a local decoding unit which decodes a first code representing a first input picture, and obtains a reference picture; a reference picture reduction unit which reduces the size of the reference picture, and obtains a reduced reference picture; a reference picture storage unit which stores the reduced reference picture; and a coding unit which obtains a second code representing a second input picture, based on a motion prediction between a reduced second input picture and the reduced reference picture obtained from the reference picture storage unit, the reduced second input picture being obtained by reducing the size of the second input picture.

The coding unit may include: an input picture reduction unit which reduces the size of the second input picture, and obtains a reduced second input picture; a coarse motion vector search unit which derives a coarse motion vector indicating a part in which a correlation between the reduced second input picture and the reduced reference picture is maximal; a reference picture reconstruction unit which obtains a reconstructed reference picture by expanding the size of the reduced reference picture obtained from the reference picture storage unit; and a difference picture generation unit which generates a difference picture between the second input picture and the reconstructed reference picture, the difference picture relating to the part indicated by the coarse motion vector, and the coding unit may code the difference picture as the second code.

The coding unit may further include a fine motion vector search unit which derives a fine motion vector indicating a part in which a correlation between the second input picture and the reconstructed reference picture is maximal, and the difference picture generation unit may generate a difference picture of the part indicated by the fine motion vector.

The coding unit may further include: a frequency transformation unit which derives a component amount of respective spatial frequencies included in the difference picture; and a quantization unit which quantizes the obtained component amount, and the coding unit may code a result of the quantization into the second code.

With the configuration as described above, the reduced reference picture obtained by reducing the size of the reference picture is stored and used for the coding of the second input picture. Therefore, the data amount of the reference picture to be stored for the motion prediction coding of the pictures can be reduced.

The moving picture coding apparatus may include a reference picture expansion unit which obtains a contrast picture by expanding the size of the reduced reference picture into the size of the reference picture; and an error calculation unit which calculate, for each corresponding pixel, an error between the reference picture and the contrast picture, wherein the reference picture storage unit stores the error together with the reduced reference picture, the reference picture reconstruction unit may obtain the reconstructed reference picture by expanding the size of the reduced reference picture obtained from the reference picture storage unit into the size of the reference picture, and further by adding the error obtained from the reference picture storage unit to the expanded reference picture.

With such technical feature, a reconstructed reference picture which is equivalent to the original reference picture can be obtained. It is therefore possible to reduce, with high probability, the amount of the data necessary for representing the reference picture, without causing a new factor which might degrade the picture quality.

The moving picture coding apparatus may further include a data amount judgment unit which judges whether or not a data amount resulting from combining the reduced reference picture and the error is greater than a data amount of the reference picture, wherein in the case where the data amount judgment unit judges that the combined data amount is greater than the data amount of the reference picture, the reference picture storage unit may store the reference picture instead of the reduced reference picture and the error, and the coding unit may obtain a motion vector indicating a part in which a correlation between the second input picture and the reference picture obtained from the reference picture storage unit is maximal, and code the difference picture of the part indicated by the motion vector as the second code.

With such configuration, it is possible to surely avoid the inconveniency of increasing, more than the conventional case, the amount of data necessary for representing a reference picture even in the worst case.

The error calculation unit may carry out a coring process in which an error less than or equal to a predetermined threshold value is disregarded.

The coding unit may further include: a frequency transformation unit which derives a component amount of respective frequency components included in the difference picture; and a quantization unit which quantizes the obtained component amount, and the coding unit may code a result of the quantization into the second code, wherein, through the coring process carried out by the error calculation unit, an error less than or equal to a predetermined threshold value is disregarded, the predetermined threshold value being determined according to a quantization width of the quantization.

With the technical features as described above, a possibility at which the data mount resulting from combining of the data representing the reduced reference picture and the data representing the error becomes less than the data amount of the original reference picture is heightened through coring. In particular, by determining a threshold value in accordance with a quantization width and using the threshold value for the coring, no substantial degradation in the picture quality will be caused in the coring.

Also, the present invention can be realized not only as such moving picture coding apparatus as described above, but also as a moving picture coding method which includes, as steps, the characteristic units equipped in the moving picture coding apparatus, and even as an integrated circuit for the use in the moving picture coding processing.

With the moving picture coding apparatus of the present invention, a reduced reference picture obtained by reducing the size of a reference picture can be stored together with an error between the reduced reference picture and the original reference picture, it is possible to reduce, with high probability, the amount of the data necessary for representing the reference picture, therefore, reduction in the memory capacity for storing the reference pictures as well as reduction in power consumption due to the decrease in memory traffic are expected.

In addition, with the processing of the reduced reference pictures, it is possible to enlarge the range for searching for a motion vector using a work memory with the capacity as same as the conventional one. Thus, it is possible to heighten the performance of motion vector search for the enlargement of picture size as required of HDTV-compatible appliances.

Further Information about Technical Background to this Application

The disclosure of Japanese Patent Application No. 2005-217849 filed on Jul. 27, 2005 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a functional block diagram showing an example of the configuration of a typical conventional picture coding apparatus;

FIG. 2 is a block diagram showing an example of the functional configuration of the image processing system operated in a digital camera, according to the embodiment;

FIG. 3 is a block diagram showing, in detail, an example of a functional configuration of a picture coding unit; and

FIG. 4 is a data flowchart showing the operation performed by the picture coding unit for processing one macroblock of an input picture.

### DESCRIPTION OF THE PREFERRED EMBODIMENT(S)

The following describes the embodiment of the present invention with reference to the drawings.

(Overall Configuration)

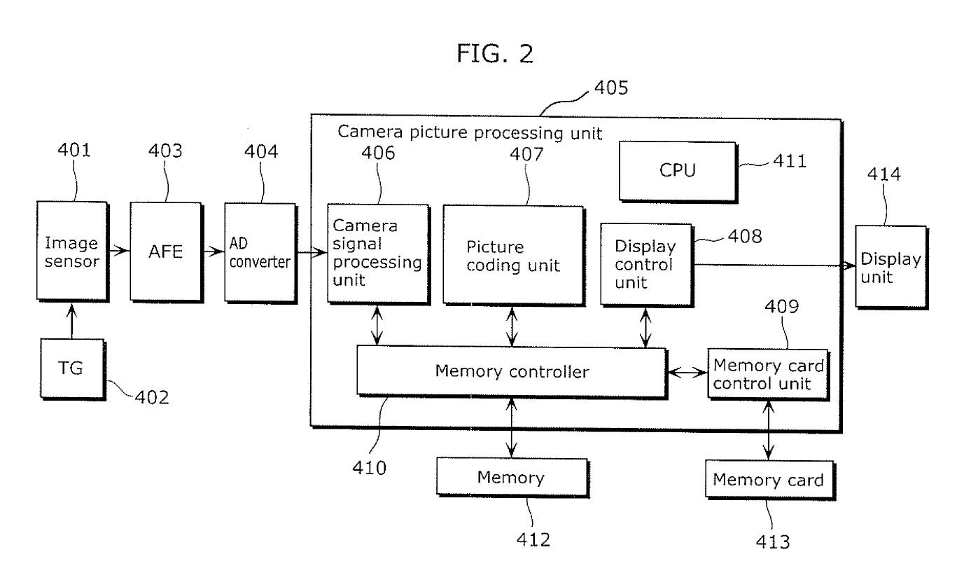

FIG. 2 is a block diagram showing an example of the functional configuration of the picture processing system operated in a digital camera, according to the embodiment of the present invention.

The picture processing system is a general one except that a picture coding unit 407 is the moving picture coding apparatus according to the present invention. The picture processing system is comprised of an image sensor 401, a Timing Generator (TG) 402, an Analog Front End (AFE) 403, an AD converter 404, a camera picture processing unit 405, a memory 412, a memory card 413 and a display unit 414.

The image sensor 401 can be realized, for example, with a Charge Coupled Device (CCD) or the like, and outputs an electric signal obtained by converting an incident light given from an optical system which is not shown in the diagram, while the AFE 403 performs a predetermined analog processing onto the electric signal, and the AD converter 404 converts the analog-processed electric signal into a digital signal and outputs it to the camera picture processing unit 405.

The camera picture processing unit 405 is a unit which displays pictures represented by the digital signal, and also codes and stores the pictures, and is configured of a camera signal processing unit 406, a picture coding unit 407, a display control unit 408, a memory card control unit 409, a memory controller 410, and a CPU 411.

The camera signal processing unit 406 converts the digital signal into a luminance signal and a chrominance signal, and the picture coding unit 407 codes the luminance signal and the chromaticity signal through data compression. The picture coding unit 407 codes, through data compression, an individual picture as a still picture, as well as a moving picture made up of pictures that are in time series.

The memory card control unit 409 stores, into a non-volatile memory card 413, a code representing a still picture obtained by the picture coding unit 407 and a code representing a moving picture.

The memory card 413 can be realized, for example, with a flash memory, a Ferroelectric Random Access Memory (FeRAM), or the like.

The display control unit 408 displays pictures onto the display unit 414. The display unit 414 can be realized, for instance, with a liquid crystal panel or the like.

The memory controller 410 temporarily stores, into the memory 412, the work data generated in the processing performed by the camera signal processing unit 406, the picture coding unit 407, the memory card control unit 409, and the display control unit 408, and also exchanges data between the units via the memory 412. The memory 412 can be realized, for example, with a Synchronous Dynamic RAM (SDRAM) or the like.

The CPU 411 controls the overall processing.

(Picture Coding Unit)

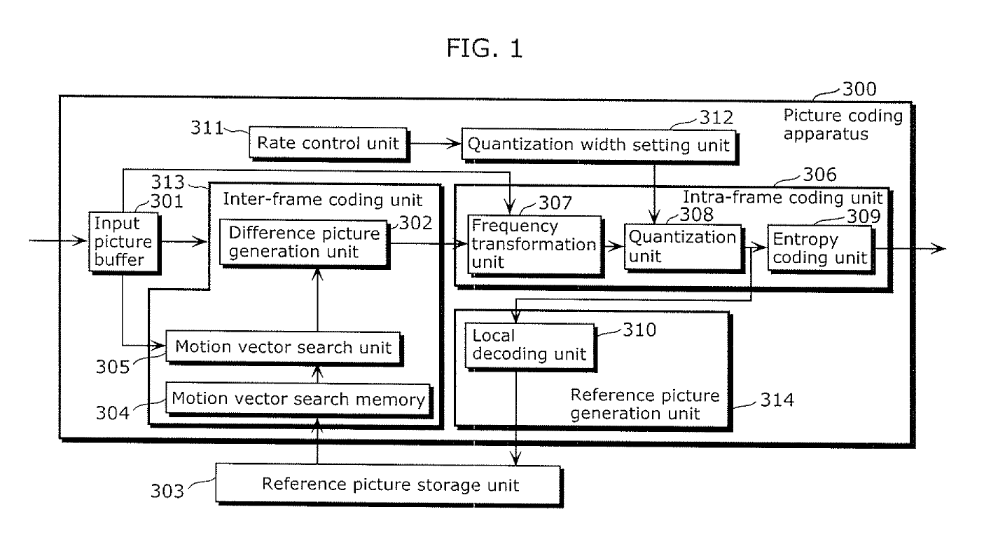

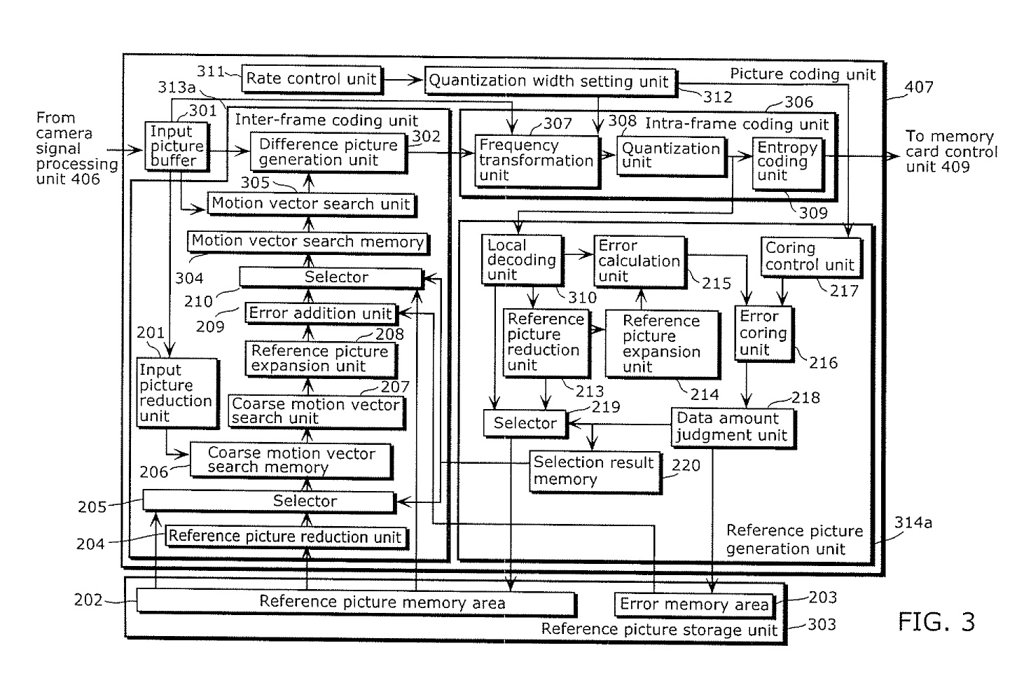

FIG. 3 is a block diagram showing in detail an example of the functional configuration of the picture coding unit 407. The picture coding unit 407 is different from the conventional picture coding apparatus 300 (see reference to FIG. 1) in the two following points: that the reference picture storage unit 303 stores a reduced reference picture obtained by reducing the size of a reference picture in the reference picture generation unit 314a; and that the inter-frame coding unit 313a searches firstly for a coarse motion vector using a reconstructed reference picture read out from the reference picture storage unit 303, and then performs coding using the reconstructed reference picture reconstructed based on the reduced reference picture.

The reference picture storage unit 303 is substantially the same as the memory 412 shown in FIG. 2. The memory controller 410, although not shown in FIG. 3, is instrumental in an access to the reference picture storage unit 303, an input from the camera signal processing unit 406, and an output to the memory card control unit 409.

The following describes, in detail, the additional components of the picture coding unit 407. For the same components as those in the picture coding apparatus 300, the same referential numbers are put and the descriptions are omitted.

A reference picture reduction unit 213, a reference picture expansion unit 214, an error calculation unit 215, a coring control unit 217, an error coring unit 216, a data amount judgment unit 218, a selection result memory 220 and a selector 219 are added in the reference picture generation unit 314a.

An input picture reduction unit 201, a reference picture reduction unit 204, a selector 205, a coarse motion vector search unit 207, a coarse motion vector search memory 206, a reference picture expansion unit 208, an error addition unit 209 and a selector 210 are added in the inter-frame coding unit 313a.

In FIG. 3, the inter-frame coding unit 313a and the intra-frame coding unit 306 are the examples of a coding unit, the reference picture expansion unit 208 and the error addition unit 209 are the examples of a reference picture reproduction unit, and the motion vector search unit 305 is an example of a fine motion vector search unit. Also, the error calculation unit 215, the coring control unit 217 and the error coring unit 216 are the examples of an error calculation unit.

In the reference picture generation unit 314a, the reference picture reduction unit 213 generates a reduced reference picture by reducing the size of a reference picture obtained by the local decoding unit 310. The reference picture expansion unit 214 generates a contrast picture by expanding the size of the reduced reference picture into the size before the reduction, while the error calculation unit 215 calculates, for each pixel, an error between the original reference picture and the contrast picture.

The reduction and expansion here means the operation of increasing and decreasing the number of pixels used for representing a picture. More precisely, such operation is performed using the well-known technology of pixel interpolation, pixel thinning, and filtering required thereof.

The coring control unit 217 determines a threshold value in accordance with a quantization width given from the quantization width setting unit 312, taking into consideration the fact that an error less than or equal to the quantization width is discarded through the quantization. The error coring unit 216 performs coring, regarding the error less than or equal to the determined threshold as zero. With regard to the representation format of errors, for example, it is desirable to represent only a pixel with an error by a pair of a pixel coordinate and an error, expecting that the data amount will be reduced through coring. According to this format, the error which has been through the coring is not included in the data mount.

The data amount judgment unit 218 judges, through comparison, whether or not the data amount resulting from combining a reduced reference picture and an error is greater than the data amount of the original reference picture, and stores the judgment result into the selection result memory 220. In the case where the combined data amount is greater than the data amount of the original one, the selector 219 selects the original sized reference picture, and in the case where the data amount of the original one is greater than the combined data amount, selects the reduced reference picture and the error, and the reference picture storage unit 303 stores the data selected by the selector 219.

The judgment of the data amount may be performed once per frame for the whole picture, or on a macroblock basis for the number of times equal to the number of the macroblocks included in one frame.

The present embodiment applies the latter case, and it is assumed that the reference pictures of one frame are stored, on a macroblock basis, into the reference picture storage unit 303 either in the format of reduced reference picture and error or in the format of original sized reference picture. A macroblock of a reference picture is called “reference block” hereinafter

Then, in the inter-frame coding unit 313a, the input picture reduction unit 201 generates a reduced input picture by reducing the size of an input picture in preparation for coarse motion vector search. The generation of a reduced input picture is performed, for example, for each macroblock of the input picture for which a motion vector is to be searched.

The reference picture reduction unit 204 obtains a reduced reference picture by reducing the size of an original sized reference picture of the reference block stored in the format of original sized reference picture in preparation for coarse motion vector search. The storage format of each reference block can be known from the result of the data amount judgment stored in the selection result memory 220.

The selector 205 selects a reduced reference picture from the reference picture storage unit 303 or from the reference picture reduction unit 204 in accordance with the storage format of each of the reference blocks located within the range of coarse motion vector search.

The coarse motion vector search unit 207 performs coarse motion vector search based on a reduced picture, using the coarse motion vector search memory 206. The coarse motion vector search can be performed, for instance, using the well-known technique such as block matching. As has already been known, by performing a motion vector search based on reduced reference picture, it is possible to make a broader search with a search memory of the same memory size as required in the motion vector search which is not based on reduced reference picture. By defining a predetermined range in the vicinity of the detected coarse motion vector as a search range of a motion vector based on an original sized picture, it is possible to efficiently obtain a motion vector with high accuracy within the limited range.

The reference picture expansion unit 208 expands the size of a reduced reference picture into the original size, for the reference blocks stored in the format of reduced reference picture and error in case of the motion vector search based on an original sized picture. The error addition unit 209 obtains a reconstructed picture by adding an error to the reduced reference picture. By adding the error, it is possible to obtain a reconstructed reference picture which is equivalent to the original reference picture. Thus, coding is performed using the original reference picture, that is, the reconstructed reference picture equivalent to the reference picture to be used at the time of reproduction. Therefore, the degradation in picture quality due to the discrepancy between the locally-decoded reference picture and the reference picture to be used at the time of reproduction can be prevented.

For the reference blocks within the search range of motion vector based on the original size picture, the selector 210 selects, as the reference picture of the original size, the reference picture stored in the reference picture storage unit 303 or the reconstructed reference picture obtained by the error addition unit 209 in accordance with the storage format.

The motion vector search unit 305, the motion vector search memory 304 and the difference picture generation unit 302 perform the conventional inter-frame coding using the original sized reference picture thus obtained and the input picture.

(Operation)

The following describes the operation of the picture coding unit 407.

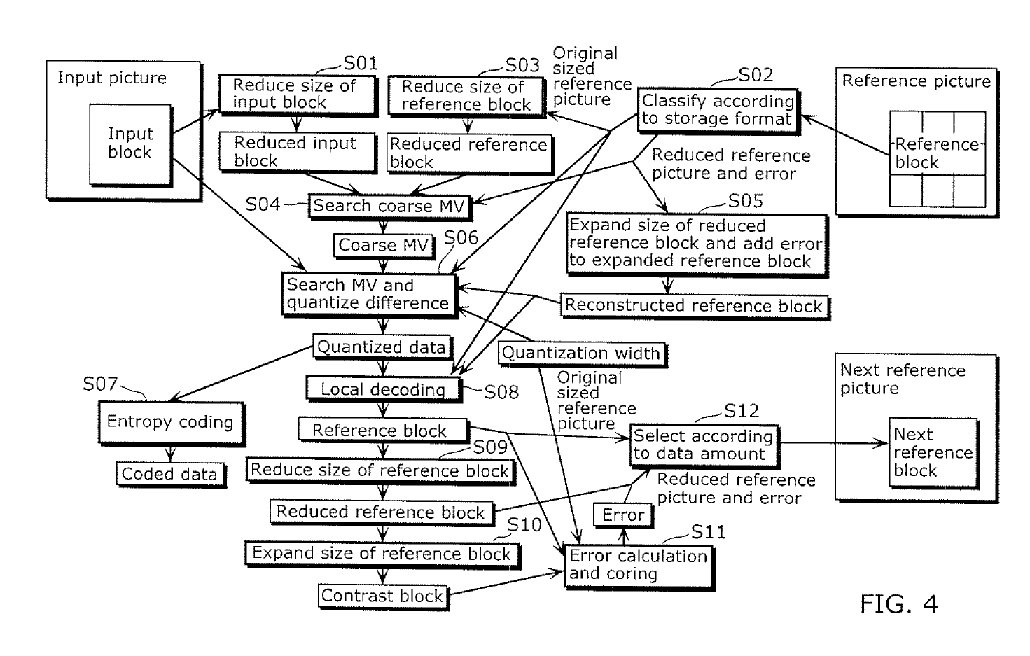

FIG. 4 is a data flowchart showing the operation of the picture coding unit 407 for processing one macroblock of an input picture, and shows a data flow as well as the respective processing steps which cause such data flow. By performing the operation onto each macroblock of the input picture, coding of the input picture is completed.

The description is provided under the assumption that the input picture on the upper left in FIG. 4 is already stored in the input picture buffer 301, and the reference picture on the upper right in FIG. 4 is already stored, for each reference block, into the reference picture storage unit 303 either in the format of original sized reference picture or in the format of reduced reference picture and error.

In order to describe the operation performed by the inter-frame coding unit 313a, it is assumed that an input picture is a picture to be inter-frame coded based on the motion prediction between the input picture and a reference picture. Note that, in the case where the input picture is a picture (e.g. I picture of the MPEG) to be independently coded, the inter-frame coding unit 313a does not operate.

The input picture reduction unit 201 generates a reduced input block by reducing the size of a macroblock (to be referred to as “input macroblock”) of the input picture (S01). The selector 205 classifies the respective reference blocks located within the search range of coarse motion vector, according to the format of the stored data (S02), and the reference picture reduction unit 204 generates a reduced reference block by reducing the size of an original sized reference picture (S03). The search range of the coarse motion vector is defined, for example, to be a reduced reference block having the same positional relation within picture as that of the reduced input block and the peripheral reduced reference blocks.

For the reference block whose original sized reference picture is stored in the reference picture storage unit 303, the coarse vector search unit 207 uses the reduced reference block obtained by the reference picture reduction unit 204, and for the reference block whose reduced reference picture and error are stored in the reference picture storage unit 303, uses the stored reduced reference picture, so as to search for a coarse motion vector (S04).

The reference picture expansion unit 208 defines the reference block located in the position indicated by the detected coarse motion vector and the peripheral reference blocks as the search range of the motion vector to be estimated based on an original sized picture. For the reference block whose reduced reference picture and error are stored, among the reference blocks located within the search range, the reference picture expansion unit 208 expands the size of the stored reduced reference picture. The error addition unit 209 obtains a reproduced reference block by adding the error to the expanded reference picture (S05).

For the reference block whose original sized picture is stored, the motion vector search unit 305 uses the stored reference picture, and for the reference block whose reduced reference picture and error are stored, uses the reconstructed reference block obtained by the error addition unit 209, so as to search for a motion vector. Then, the difference picture generation unit 302 generates a difference picture using the stored reference picture and the reconstructed reference block.

A difference picture is, as has conventionally been, transformed into the quantization data of the spatial frequency components (S06). The quantized data is then entropy-coded into coded data by the entropy coding unit 309 (S07).

Note that the motion vector search which is based on an original sized picture and is performed by the motion vector search unit 305 can be omitted. In that case, a coarse motion vector can be scaled into original size for use. The omission of the motion vector search based on an original sized picture may contain a risk of reducing more or less a compression rate due to the failure in obtaining the most suitable correlation. However, it is possible to achieve high-speed processing and reduction in the size of circuit to be equipped for the picture coding unit 407.

The local decoding unit 310 obtains a reference block by decoding quantized data (S08). The reference picture reduction unit 204 obtains a reduced reference block by reducing the size of the reference block (S09), while the reference picture expansion unit 208 obtains a contrast block by expanding the size of the reduced reference block into the size before the reduction, that is, the same size as that of the reference block (S10).

The error calculation unit 215 calculates, for each pixel, an error between the reference block and the contrast block, and the error coring unit 216 performs coring of the error data (S11).

The data amount judgment unit 218 judges, through comparison, whether or not the data amount resulting from combining the reduced reference block and the error is greater than the data amount of the reference block. In the case where the combined data amount is greater than the data amount of the reference block, the selector 219 selects the reference block, and in the case where the latter is greater than the former, selects the reduced reference block and the error, and the reference picture storage unit 303 stores the data selected by the selector 219 as a reference block of the next reference picture to be compared with the next input picture (S12).

(Conclusion)

As has been described above, with the picture coding unit 407, the reference picture storage unit 303 stores a reduced reference picture obtained by reducing the size of a reference picture in the reference picture generation unit 314a, and the inter-frame coding unit 313a performs coding using a reconstructed reference picture reconstructed, using the reduced reference picture as the conventional reference picture, after having searched for a coarse motion vector using the reduced reference picture read out from the reference picture storage unit 303. Therefore, the data amount of the reference picture to be used in the motion prediction coding can be reduced compared to the conventional case.

According to the structure in which a reduced reference picture is stored in the reference picture storage unit 303 together with an error, and a reconstructed reference picture is obtained by expanding the size of the reduced reference picture and adding the error to the expanded reference picture, it is possible to obtain the reconstructed reference picture which is equivalent to the original reference picture. Thus, it is possible to reduce with high probability the amount of data necessary for representing a reference picture, without causing a new factor which might degrade picture quality.

According to the structure in which, the data amount judgment unit 218 compares the data amount resulting from combining a reduced reference picture and an error is compared with the data amount of the original reference picture, and stores the data with less amount into the reference picture storage unit 303, it is possible to surely avoid the inconvenience of increasing, more than the conventional case, the amount of data necessary for representing a reference picture in the worst case.

With the structure in which the error coring unit 216 performs coring onto an error, there is less possibility that the data amount resulting from combining a reduced reference picture and an error is less than the data amount of the original reference picture. In that case, it is possible for the coring control unit 217 to perform coring which does not cause substantial degradation in picture quality, by determining a threshold value in accordance with a quantization width and using the determined threshold value in the coring.

(Variation)

The picture coding unit 407 can be realized as a semiconductor integrated circuit, for example. In that case, each of the units in the picture coding unit 407 shown in FIG. 3 can be realized as a circuit block which performs the corresponding function.

The picture coding unit 407 may be realized as a software function to be operated by a computer. In that case, the picture coding unit 407 is substantially configured of a processor, a memory storing a program to be executed by the processor, and the like, and each of the units in the picture coding unit 407 shown in FIG. 3 shows a program module which causes the processor to execute the corresponding function. The processor can be selected from among a Central Processing Unit (CPU), a Digital Signal Processor (DSP), and the like.

Moreover, the entire camera picture processing unit 405 including the picture coding unit 407 shown in FIG. 2 may be implemented as a semiconductor integrated circuit.

In any of the above-mentioned implementation cases, the effects of reducing, with high probability, the data amount of the reference picture to be stored for use in the motion prediction coding, which are unique to the present invention, can be achieved.

Although only one exemplary embodiment of this invention has been described in detail above, those skilled in the art will readily appreciate that many modifications are possible in the exemplary embodiment without materially departing from the novel teachings and advantages of this invention. Accordingly, all such modifications are intended to be included within the scope of this invention.

### INDUSTRIAL APPLICABILITY

The moving picture coding apparatus of the present invention is suitable for the use in a moving picture recording apparatus, and is particularly suitable in the case of realizing a moving picture recording function in a device, such as a digital camera and a cellular phone, in which a hardware size and a power capacity are relatively limited.

What is claimed is:

1. A moving picture coding apparatus which codes a moving picture made up of input pictures which are in time series, said apparatus comprising:
a local decoding unit operable to decode a first code representing a first input picture, and to obtain a reference picture;
a reference picture reduction unit operable to reduce the size of the reference picture, and to obtain a reduced reference picture;
a reference picture storage unit operable to store the reduced reference picture; and
a coding unit operable to obtain a second code representing a second input picture, based on a motion prediction between a reduced second input picture and the reduced reference picture obtained from said reference picture storage unit, the reduced second input picture being obtained by reducing the size of the second input picture.

2. The moving picture coding apparatus according to claim 1,
wherein said coding unit includes:
an input picture reduction unit operable to reduce the size of the second input picture, and to obtain a reduced second input picture;
a coarse motion vector search unit operable to derive a coarse motion vector indicating a part in which a correlation between the reduced second input picture and the reduced reference picture is maximal;
a reference picture reconstruction unit operable to obtain a reconstructed reference picture by expanding the size of the reduced reference picture obtained from said reference picture storage unit; and
a difference picture generation unit operable to generate a difference picture between the second input picture and the reconstructed reference picture, the difference picture relating to the part indicated by the coarse motion vector, and
said coding unit is operable to code the difference picture into the second code.

3. The moving picture coding apparatus according to claim 2,
wherein said coding unit further includes
a fine motion vector search unit operable to derive a fine motion vector indicating a part in which a correlation between the second input picture and the reconstructed reference picture is maximal, and
said difference picture generation unit is operable to generate a difference picture of the part indicated by the fine motion vector.

4. The moving picture coding apparatus according to claim 2,
wherein said coding unit further includes:
a frequency transformation unit operable to derive a component amount of respective spatial frequencies included in the difference picture; and
a quantization unit operable to quantize the obtained component amount, and
said coding unit is operable to code a result of the quantization into the second code.

5. The moving picture coding apparatus according to claim 2, further comprising:
a reference picture expansion unit operable to obtain a contrast picture by expanding the size of the reduced reference picture into the size of the reference picture; and
an error calculation unit operable to calculate, for each corresponding pixel, an error between the reference picture and the contrast picture,
wherein said reference picture storage unit is operable to store the error together with the reduced reference picture,
said reference picture reconstruction unit is operable to obtain the reconstructed reference picture by expanding the size of the reduced reference picture obtained from said reference picture storage unit into the size of the reference picture, and further adding the error obtained from said reference picture storage unit to the expanded reference picture.

6. The moving picture coding apparatus according to claim 5, further comprising
a data amount judgment unit operable to judge whether or not a data amount resulting from combining the reduced reference picture and the error is greater than a data amount of the reference picture,
wherein in the case where said data amount judgment unit judges that the combined data amount is greater than the data amount of the reference picture,
said reference picture storage unit is operable to store the reference picture instead of the reduced reference picture and the error, and
said coding unit is operable to obtain a motion vector indicating a part in which a correlation between the second input picture and the reference picture obtained from said reference picture storage unit is maximal, and to code the difference picture of the part indicated by the motion vector as the second code.

7. The moving picture coding apparatus according to claim 5,
wherein said error calculation unit is operable to carry out a coring process in which an error less than or equal to a predetermined threshold value is disregarded.

8. The moving picture coding apparatus according to claim 7,
wherein said coding unit further includes:
a frequency transformation unit operable to derive a component amount of respective frequency components included in the difference picture; and
a quantization unit operable to quantize the obtained component amount, and
said coding unit is operable to code a result of the quantization into the second code,
wherein, through the coring process carried out by said error calculation unit, an error less than or equal to a predetermined threshold value is disregarded, the predetermined threshold value being determined according to a quantization width of the quantization.

9. A moving picture coding method for coding a moving picture made up of input pictures which are in time series, said method comprising:
decoding a first code representing a first input picture, and to obtain a reference picture;
reducing the size of the reference picture, and to obtain a reduced reference picture;
storing the reduced reference picture; and
obtaining a second code representing a second input picture, based on a motion prediction between a reduced second input picture and the reduced reference picture stored in said storing, the reduced second input picture being obtained by reducing the size of the second input picture.

10. A program for coding a moving picture made up of input pictures which are in time series, said program causing a computer to execute:
decoding a first code representing a first input picture, and to obtain a reference picture;
reducing the size of the reference picture, and to obtain a reduced reference picture;
storing the reduced reference picture; and
obtaining a second code representing a second input picture, based on a motion prediction between a reduced second input picture and the reduced reference picture stored in said storing, the reduced second input picture being obtained by reducing the size of the second input picture.
